(19) United States
(12) Patent Application Publication
(10) Pub. No.: US 2008/0150840 A1
(43) Pub. Date: Jun. 26, 2008

(54) Plasma display panel and driving method thereof

(76) Inventor: Kyung-won Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/000,505

(22) Filed: Dec. 13, 2007

(30) Foreign Application Priority Data
Dec. 20, 2006 (KR) 10-2006-0131036

(51) Int. Cl. G09G 3/28

(52) U.S. Cl. 345/67

(57) ABSTRACT

Example embodiments relate to apparatuses and methods for driving a display device, having a display panel including a plurality of first electrodes, a plurality of second electrodes and a plurality of third electrodes formed crossing the first electrodes and the second electrodes, and a plurality of discharge cells formed by the first electrodes, the second electrodes and the third electrodes. The apparatuses may further include a driver adapted to transmit a drive signal to the display panel, and a counter adapted to count an external signal and output a result to the driver. The driver may delay a time to reach a discharge firing voltage in the first electrodes and the second electrodes by controlling the drive signal in accordance with the result generated by the counter.

### BACKGROUND OF THE INVENTION

1. Field of the Invention

Example embodiments relate to a plasma display panel and a driving method thereof.

2. Description of the Related Art

A plasma display panel (PDP) is a display device for displaying letters, numbers and/or images using plasma generated by a gas discharge. Further, a plasma display apparatus may include a plurality of discharge cells arranged in a matrix.

To display images on a PDP, a frame may be divided into a plurality of subfields having allocated weight values. Each of the subfields may include a reset period, an address period and a sustain period. The reset period may be a period for resetting discharge cells so as to steadily perform a subsequent address period, the address period may be a period for selecting cells to be turned on (or not to be turned on) from a plurality of discharge cells, and the sustain period may be a period for performing an electric discharge to actually display an image in the cells to be turned on.

However, in some occurrences, an erroneous discharge may be provided in the reset period, the address period and/or the sustain period. The erroneous discharge may be caused by a deterioration of a phosphor and/or a loss of a dielectric material in the PDP when used for an extended period.

### SUMMARY OF THE INVENTION

Example embodiments are therefore directed to a plasma display panel, and a driving method thereof, which substantially overcome one or more of the problems due to the limitations and disadvantages of the related art.

It is therefore a feature of example embodiments to provide a plasma display panel, and driving method thereof, capable of reducing an erroneous discharge by changing a driving waveform according to its use time.

At least one of the above and other features of example embodiments may provide an apparatus for driving a display device, having a display panel including a plurality of first electrodes, a plurality of second electrodes and a plurality of third electrodes formed crossing the first electrodes and the second electrodes, and a plurality of discharge cells formed by the first electrodes, the second electrodes and the third electrodes. The apparatus may further include a driver adapted to transmit a drive signal to the display panel, and a counter adapted to count an external signal so as to output a result to the driver. The driver may delay a time to reach a discharge firing voltage in the first electrodes and the second electrodes by controlling the drive signal in accordance with the result generated by the counter

The apparatus may further include an image processing unit adapted to receive an image signal from the outside and may generate an internal image signal, and a controller adapted to receive the internal image signal from the image processing unit to control the driver.

The counter may receive a vertical synchronizing signal from an image processing unit and may count the vertical synchronizing signal. The counted vertical synchronizing signal may be compared to a set value. Further, when the counted vertical synchronizing signal exceeds the set value, the driver may be set to change a driving waveform output. The counter may also determine a use time of the plasma display panel using the counted vertical synchronizing signal.

The driver may include a first driver adapted to transmit a drive signal to the first electrodes, a second driver adapted to transmit a drive signal to the second electrodes, and a third driver adapted to transmit a drive signal to the third electrodes. The second driver may control a voltage of the drive signal.

The drive signal may further include a reset period, an address period and a sustain substrate. The drive signal may control a waveform of the reset period. The waveform may control in accordance with an effective gap between the first electrodes and the second electrodes. The reset period may be divided into a rising time and a falling time, and may control a gradient of the falling time. The gradient may be applied to the second electrodes so as to reduce the voltage.

The controller may control the driver to divide one frame into a plurality of subfields each including a reset period, an address period and a sustain period and drive a plurality of the subfields.

At least one of the above and other features of example embodiments may provide a method for driving a display panel including a plurality of first electrodes, a plurality of second electrodes and a plurality of third electrodes crossing the first electrodes and the second electrodes, and a plurality of discharge cells formed by the first electrodes, the second electrodes and the third electrodes. The method may further include transmitting a drive signal to the display panel, counting an externally generated signal, and output a result transmitted by the driver signal, and delaying a time to reach a discharge firing voltage in the first electrodes and the second electrodes of the display panel in accordance with the output result.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates a perspective view of an internal configuration of a plasma display panel according to an example embodiment;

FIG. 2 illustrates a block diagram of an apparatus for driving a plasma display panel according to an example embodiment;

FIG. 3 illustrates a timing diagram of a driving waveform generated in a driver of a plasma display panel according to an example embodiment; and

FIG. 4 illustrates a flow chart of a driving method for driving a plasma display panel according to an example embodiment.

### DETAILED DESCRIPTION OF THE INVENTION

Korean Patent Application No. 10-2006-0131036, filed on Dec. 20, 2006, in the Korean Intellectual Property Office, and entitled: “Plasma Display Panel and Driving Method Thereof,” is incorporated by reference herein in its entirety.

Example embodiments will now be described more fully hereinafter with reference to the accompanying drawings. Example embodiments may, however, be embodied in different forms and should not be construed as limited to the embodiments set forth herein. Rather, these example embodiments are provided so that this disclosure will be thorough and complete, and will fully convey the scope of the invention to those skilled in the art.

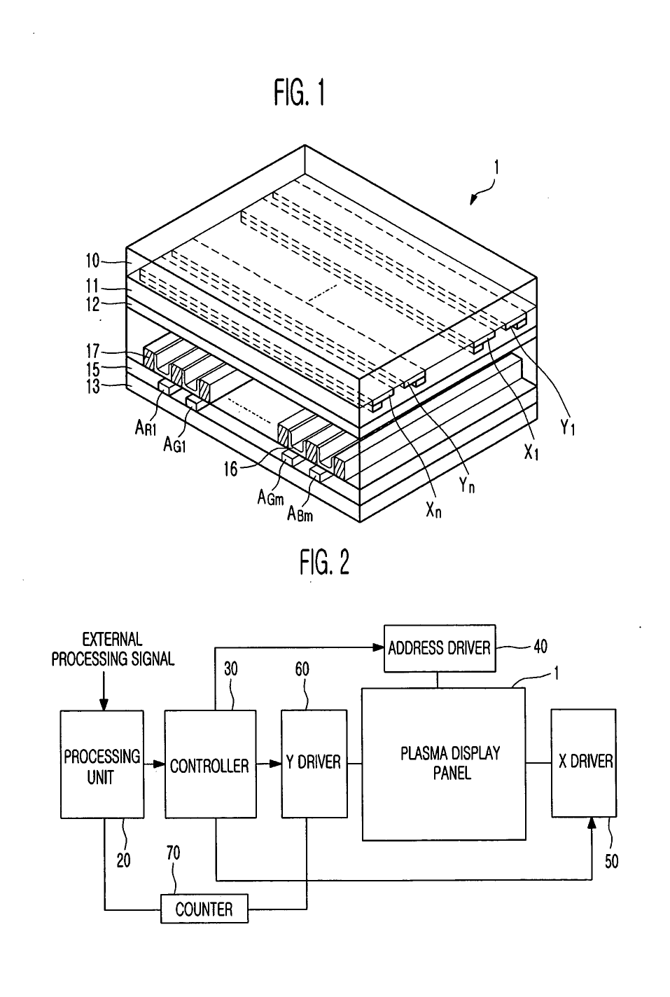

FIG. 1 illustrates a perspective view of an internal configuration of a plasma display panel (PDP) according to an example embodiment. Referring to FIG. 1, the PDP 1 may include a first substrate 10, a second substrate 13 formed to face the first substrate 10, a first dielectric layer 11, a second dielectric layer 15, a photolumiscent layer 16, a barrier rib 17, and a protective layer 12 formed between the first substrate 10 and the second substrate 13. The second substrate 13 may include address electrode lines (A_{R1}˜A_{Bm}) formed thereon, and the first substrate 10 may include Y electrode lines (Y₁˜Yₙ) and X electrode lines (X₁˜Xₙ) formed thereon.

The address electrode lines (A_{R1}˜A_{Bm}) may be formed on a frontside of the second substrate 13 with a constant pattern, and the second dielectric layer 15 may be formed over the address electrode lines (A_{R1}˜A_{Bm}) over all (or substantially all) of the second substrate 13. The barrier ribs 17 may be formed on a frontside of the second dielectric layer 15 in a direction arranged substantially parallel with the address electrode lines (A_{R1}˜A_{Bm}). It should be appreciated that other configurations of the address electrode lines (A_{R1}˜A_{Bm}) and the barrier ribs 17 may be employed.

Further, magnesium oxide (MgO), for example, may be used as the first and second dielectric layers 11 and 15. It should be appreciated that other materials may be employed to form the dielectric layers.

The barrier ribs 17 may partially define electric discharge regions of each of the discharge cells, and may serve to prevent and/or reduce an optical interference between the discharge cells. The photolumiscent layer 16 may be formed on the second dielectric layer 15 between the barrier ribs 17 formed on the second substrate 13.

The X electrode lines (X₁˜Xₙ) and the Y electrode lines (Y₁˜Yₙ) may be formed on a rearside of the first substrate 10 with a regular pattern so as to vertically cross the address electrode lines (A_{R1}˜A_{Bm}). It should be appreciated that other configurations of the X electrode lines (X₁˜Xₙ) and the Y electrode lines (Y₁˜Yₙ) may be employed, e.g., providing the X electrode lines (X₁˜Xₙ) and the Y electrode lines (Y₁˜Yₙ) on a frontside of the first substrate 10.

Discharge cells may correspond to intersecting portions of the address electrode lines (A_{R1}˜A_{Bm}) with the X and Y electrode lines (X₁˜Xₙ) and (Y₁˜Yₙ). Each of the X electrode lines (X₁˜Xₙ) and the Y electrode lines (Y₁˜Yₙ) may be formed by coupling a transparent electrode line of transparent conductive materials such as, but not limited to, ITO, with a metal electrode line to enhance conductivity. In example embodiments, the X electrode lines (X₁˜Xₙ) may serve as sustain electrodes in the discharge cells, the Y electrode lines (Y₁˜Yₙ) may serve as scan electrodes in the discharge cell, and the address lines (A_{R1}˜A_{Bm}) may serve as address electrodes in the discharge cells.

It should be appreciated that if the PDP is continuously used, the dielectric layers 11 and 15 may deteriorate, which may bring the X electrode lines (X₁˜Xₙ) and the Y electrode lines (Y₁˜Yₙ) effectively closer together. Accordingly, if the X electrode lines (X₁˜Xₙ) and the Y electrode lines (Y₁˜Yₙ) are effectively closer as a result of less dielectric material therebetween, a discharge firing voltage may be reduced, e.g., an erroneous electric discharge may occur.

FIG. 2 illustrates a block diagram of an apparatus for driving a PDP according to an example embodiment. Referring to FIG. 2, the driving apparatus of the PDP 1 may include an image processing unit 20, a controller 30, an address driver 40, an X driver 50, a Y driver 60 and a counter 70. It should be appreciated that other devices or elements may be included in the driving apparatus.

The image processing unit 20 may convert an external analog data signal to a digital signal to generate internal signals, e.g., a digital signal, a clock signal, and/or vertical and horizontal synchronizing signals, each having, e.g., 8-bit red, green and blue colors. It should be appreciated that other signals may be generated by the image processing unit 20.

The controller 30 may generate drive control signals from the image processing unit 20 according to an internal image signal, and may transmit the drive control signals to the drivers, e.g., the address driver 40, the X driver 50, the Y driver 60. It should be appreciated that other drivers besides the ones mentioned above may be employed and/or at least two of the drivers may be variably arranged in a single unit.

The address driver 40 may process an address signal among the drive control signals from the controller 30 to generate a display data signal, and may apply the generated display data signal to the address electrode lines (A_{R1}˜A_{Bm}).

The X driver 50 may process an X drive control signal among the drive control signals from the controller 30, and may apply the processed X drive control signal to the X electrode lines (X₁˜Xₙ).

The Y driver 60 may process a Y drive control signal among the drive control signals from the controller 30, and may apply the processed Y drive control signal to the Y electrode lines (Y₁˜Yₙ).

The counter 70 may count a vertical synchronizing signal generated in the image processing unit 20, and may determine a use time of the PDP 1 using a counted number of the vertical synchronizing signals. After a specific amount of time, a waveform of the driving waveform output from the Y driver 60 may be controlled by transmitting a signal to the Y driver 60.

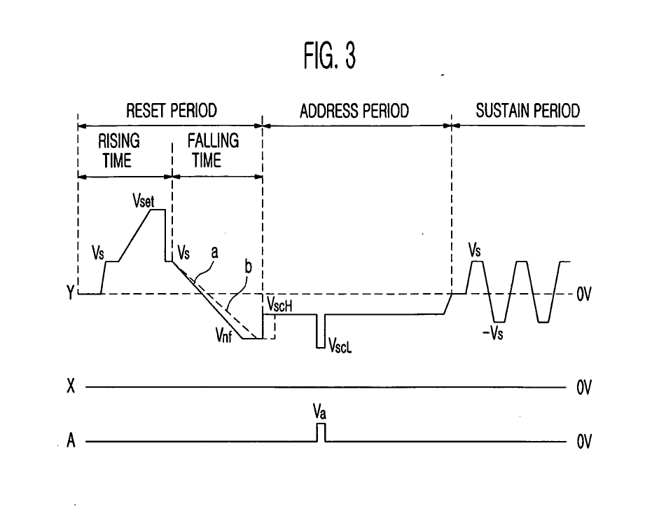

FIG. 3 illustrates a timing diagram of a driving waveform generated in a driver of the PDP 1 according to an example embodiment.

Referring to FIG. 3, “a” may represent a driving waveform transmitted during a normal operation and “b” may represent a driving waveform transmitted when a dielectric is deteriorated after being used for an extended period of time. A voltage applied to an X electrode may be transmitted to by the X driver 50, a voltage applied to a Y electrode may be transmitted by the Y driver 60, and a voltage applied to an address electrode may be transmitted by the address driver 40. Further, a driving waveform of one subfield may include a reset period, an address period and a sustain period. The reset period may include a rising time and a falling time.

In an example embodiment, the driving waveform as shown in “a”, may illustrate a voltage in the Y electrode being gradually increased from a Vs voltage to a Vset voltage while maintaining a voltage in the X electrode and the address electrode at a reference voltage, e.g., 0V, during the rising time of the reset period. The voltage of the Y electrode may be increased in a ramp type manner (shown in FIG. 3). A weak electric discharge may then occur between the Y electrode and the X electrode, and between the Y electrode and the address electrode, during a period when the voltage of the Y electrode is increased, e.g., during the rising time. At this time, a (−) wall charge formed in the Y electrode and a (+) wall charge formed in the X electrode and the address electrode may be erased and, therefore, the cells may be reset to non-emitting cells. Further, a difference between a Vnf voltage and an X electrode voltage may approximately be set to a discharge firing voltage between the Y electrode and the X electrode. A wall voltage between the Y electrode and the X electrode may then approach approximately 0V. As a result, an erroneous discharge may be prevented and/or reduced during a sustain period in cells in which an address discharge may not be generated during the address period.

A VscL voltage and a Va voltage may be applied to the Y electrode and the address electrode, respectively, to select light-emitting cells during the address period, i.e., cells that are to emit light during a subsequent sustain period. A VscH voltage may be applied to the Y electrode of cells that are not to emit light during a subsequent sustain period, i.e., Y electrode of cells that are not to be selected during the respective address period. The VscH voltage may be higher than the VscL voltage. Further, the reference voltage, e.g., 0V, may be applied to the address electrode of the cells selected as non-emitting cells. The Va voltage that may be applied to the address electrodes of selected light emitting cells may be higher than the reference voltage. An electric discharge may then occur in the cells including an address electrode in which the Va voltage may be applied, and a Y electrode in which the VscL voltage may be applied. In such cases, a (+) wall charge may be formed on the Y electrode and a (−) wall charge may be formed on the address and X electrodes, respectively.

A sustain discharge pulse alternately having a Vs voltage and a −Vs voltage may be applied to the Y electrode during the sustain period to induce a sustain discharge in the light emitting cells, i.e., the cells selected during the previous address period. For example, a wall voltage may be formed in the cells selected from the light emitting cells during the address period so that the Y electrode may have a higher potential than that of the X electrode. Accordingly, the sustain discharge may occur between the Y electrode and the X electrode because the sustain discharge pulse having the Vs voltage may be firstly applied to the Y electrode while maintaining the address electrode and the X electrode at the reference voltage during the sustain period. In example embodiments, the Vs voltage may be set to a lower level than a discharge firing voltage between the Y electrode and the X electrode, and a (Vs+Vwxy) voltage may be set to a higher level than a voltage (Vfxy). As a result of the sustain discharge, the (−) wall charge may be formed in the Y electrode, and the (+) wall charge may be applied to the X electrode and the address electrode, and then a wall voltage (Vwxy) may be formed so that the X electrode may have a higher potential than that of the Y electrode.

The sustain discharge pulse having the −Vs voltage may then be applied to the Y electrode to cause a sustain discharge between the Y electrode and the X electrode. As a result, the (+) wall charge may be formed on the Y electrode, and the (−) wall charge may be formed on the X electrode and the address electrode, and therefore, the sustain discharge may be generated when the Vs voltage is applied to the Y electrode. The sustain discharge pulse alternately having the Vs voltage and the −Vs voltage may then be applied to the Y electrode as for a number corresponding to a weight value of the corresponding subfield.

However, if the PDP is continuously used, a dielectric may deteriorate, which may bring the X electrode and Y electrode effectively closer together. Therefore, if the X electrode and the Y electrode are effectively closer as a result of less dielectric material therebetween, the discharge firing voltage (Vfxy) may be reduced, increasing the possibility of misfiring, i.e., erroneous discharge.

Accordingly, if the driving waveform applied to the Y electrode is modified (as shown in “b”), e.g., if a gradient of the driving waveform, applied to the Y electrode during the falling time of the reset period, is reduced, then a voltage applied to the Y electrode may be more slowly reduced, which may prevent a reduction in the discharge firing voltage, e.g., reduce occurrence of erroneous electric discharge.

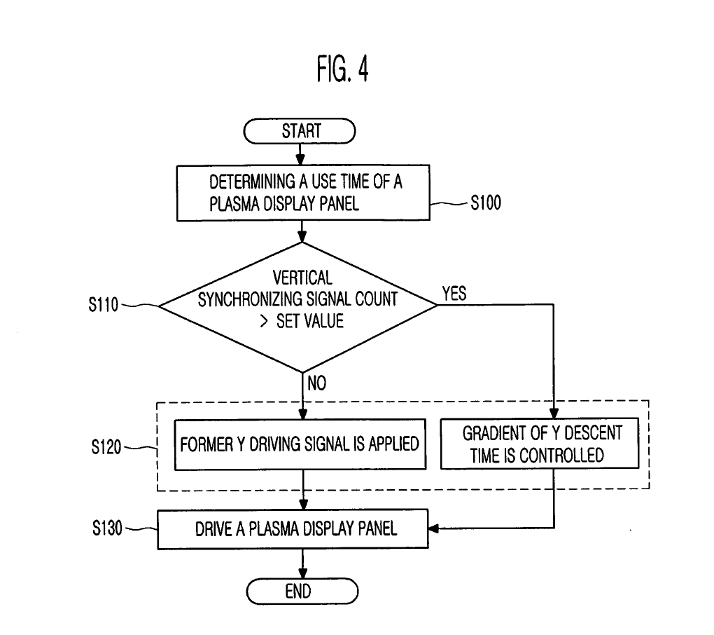

FIG. 4 illustrates a flow chart of a driving waveform changed in an apparatus for driving a PDP according to an example embodiment.

Referring to FIG. 4, in S100, a use time of a plasma display panel may be determined. A vertical synchronizing signal may be received and counted to determine the use time of the plasma display panel. The vertical synchronizing signal may be used and counted to control a discharge voltage used in the plasma display panel.

In S110, the counted value of the vertical synchronizing signal as compared to a set value exceeds the set value, so that a driving waveform output from the Y driver may be charged in S120. Otherwise, in S120, the existing driving waveform may be output from the Y driver if the counted value is less than the set value.

Further, in S120, the driving waveform output from the Y driver may include a reset period, an address period and a sustain period. The reset period may be divided into a rising time and a falling time. At this time, if the number of vertical synchronizing signals exceeds the set value, a gradient of a descent time may be controlled during the reset period to extend the falling time of the driving waveform transmitted to the Y electrode. This may prevent and/or minimize a reduction in the discharge firing voltage. In S130, the PDP may be driven to correspond to the driving waveform output from the Y driver. The PDP may not induce an erroneous electric discharge by the driving waveform output from the Y driver because the driving waveform output from the Y driver may be controlled to correspond to a gap (e.g., distance, space, opening, break, interruption, etc.) between the X electrode and the Y electrode.

Example embodiments may provide an electric discharge effectively controlled by controlling a driving waveform output from a driver.

In the figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will also be understood that, although the terms “first”, “second” and etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of example embodiments.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An apparatus for driving a display device, the apparatus comprising:
a display panel including a plurality of first electrodes, a plurality of second electrodes and a plurality of third electrodes formed crossing the first electrodes and the second electrodes, and having a plurality of discharge cells formed by the first electrodes, the second electrodes and the third electrodes;
a driver adapted to transmit a drive signal to the plasma display panel; and
a counter adapted to count an external signal and to output a result to the driver,
wherein the driver delays a time to reach a discharge firing voltage in the first electrodes and the second electrodes by controlling the drive signal in accordance with the result generated by the counter.

2. The apparatus for driving a display device as claimed in claim 1, further comprising:
an image processing unit adapted to receive an image signal from the outside and adapted to generate an internal image signal; and
a controller adapted to receive the internal image signal from the image processing unit to control the driver.

3. The apparatus for driving a display device as claimed in claim 1, wherein the counter is adapted to receive a vertical synchronizing signal from an image processing unit and adapted to count the vertical synchronizing signal.

4. The apparatus for driving a display device as claimed in claim 3, wherein the counted vertical synchronizing signal is compared to a set value.

5. The apparatus for driving a display device as claimed in claim 4, wherein when the counted vertical synchronizing signal exceeds the set value, the driver is set to change a driving waveform output.

6. The apparatus for driving a display device as claimed in claim 3, wherein the counter is adapted to determine a use time of the display panel using the counted vertical synchronizing signal.

7. The apparatus for driving a display device as claimed in claim 1, wherein the driver comprises:
a first driver adapted to transmit a drive signal to the first electrodes;
a second driver adapted to transmit a drive signal to the second electrodes; and
a third driver adapted to transmit a drive signal to the third electrodes.

8. The apparatus for driving a display device as claimed in claim 7, wherein the second driver is adapted to control a voltage of the drive signal.

9. The apparatus for driving a display device as claimed in claim 8, wherein the drive signal includes a reset period, an address period and a sustain substrate, and controls a waveform of the reset period.

10. The apparatus for driving a display device as claimed in claim 9, wherein the waveform is controlled in accordance with an effective gap between the first electrodes and the second electrodes.

11. The apparatus for driving a display device as claimed in claim 9, wherein the reset period is divided into a rising time and a falling time, and controls a gradient of the falling time.

12. The apparatus for driving a display device as claimed in claim 11, wherein the gradient is applied to the second electrodes so as to reduce the voltage.

13. The apparatus for driving a display device as claimed in claim 1, wherein the controller is adapted to control the driver to divide one frame into a plurality of subfields, each including a reset period, an address period and a sustain period, and adapted to drive a plurality of the subfields.

14. A method for driving a display panel including a plurality of first electrodes, a plurality of second electrodes and a plurality of third electrodes crossing the first electrodes and the second electrodes, and having a plurality of discharge cells formed by the first electrodes, the second electrodes and the third electrodes, the method comprising:
transmitting a drive signal to the display panel;
counting an externally generated signal, and output a result; and
delaying a time to reach a discharge firing voltage in the first electrodes and the second electrodes of the display panel in accordance with the output result.

15. The method for driving a display device as claimed in claim 14, wherein the counted signal is a vertical synchronizing signal from an image processing unit.

16. The method for driving a display device as claimed in claim 15, wherein the counted vertical synchronizing signal is compared to a set value.

17. The method for driving a display device as claimed in claim 17, wherein when the counted vertical synchronizing signal exceeds the set value, a driver is set to change a driving waveform output.

18. The method for driving a display device as claimed in claim 16, further comprising determining a use time of the display panel using the counted vertical synchronizing signal.

19. The method for driving a display device as claimed in claim 14, wherein the drive signal includes a reset period, an address period and a sustain period.

20. The method for driving a display device as claimed in claim 19, wherein the reset period includes a rising time and a falling time, and controls a gradient of the falling time.
